(19) United States
(12) Patent Application Publication
(10) Pub. No.: US 2008/0289540 A1
(43) Pub. Date: Nov. 27, 2008

(54) Procedure for the preparation of a thermal, flexible and light coating paint

(76) Inventor: Ulises Eladio Perez-Hinojosa, Garza Garcia (MX)

Correspondence Address: BREINER & BREINER, L.L.C., P.O. BOX 320160, ALEXANDRIA, VA, 22320-0160, US

(21) Appl. No.: 11/822,339

(22) Filed: Jul. 5, 2007

(30) Foreign Application Priority Data
May 22, 2007 (MX) MX/A/2007/006148

(51) Int. Cl. C09D 5/00

(52) U.S. Cl. 106/409; 106/505

(57) ABSTRACT

The invention involves a procedure in which by the combination of certain components, a thermal, flexible and light coating paint is obtained. This paint offers insulation properties with a low film thickness. This coating paint offers better insulation properties than other insulators with a higher thickness while not requiring any additional protection. These properties are due to the internal structure of the coating paint in which internal caverns are formed by the reaction of ramified chain polymers, addition of materials, and a balance of certain elements. These characteristics are impossible to get in traditional coating paints.

### BACKGROUND OF THE INVENTION

Thermal insulators, from the very beginning have been used or manufactured with the idea or concept of using volume and/or thickness of the insulation in order to be used as a thermal insulation, but in order for this insulator to last it has to be protected from the solar rays, water as well as to avoid damage due to direct exposition to the environment.

The present invention has as an objective, a procedure in which with the combination of certain components, the thermal insulation coating paint is obtained with features such as a low thickness film, as well as a flexible and light properties, in addition to give more efficient thermal insulation properties than common insulation materials used nowadays, this is achieved with a lower thickness, better thermal insulation properties and without protection for solar rays, water, and the environment than other common insulation material that insulate with a higher volume, thickness and need protection against solar rays, water, and the environment. These properties are achieved due to the formation of flexible and plastic caverns in its internal structure, which are formed by the reaction of a ramified chain polymer, as well as the addition of controlled solutions. These features in normal systems are impossible to achieve.

### DETAILED DESCRIPTION OF THE PRESENT INVENTION

This invention refers to a procedure for the preparation of a thermal, light and flexible coating paint, made by mixing a ramified chain polymer with other controlled substances, in a controlled temperature of 77° F. to 86° F. a 50:5 with a 35% of controlled humidity (deionized water).

In a portion of a ramified chain polymer, different controlled substances are added until ellipsoidal caverns are formed; this is done with a controlled pH, immediately after the thixotropy of the modified acrylic is controlled, the polymer content is increased until a slightly endothermic reaction occurs. The whole process is developed in a range of pH from 10.5 to 11.0.

The procedure described can be better understood with the following examples in order to illustrate the advantages of this invention, but it does not have the intention of limiting its application or its use, as a thermal insulator.

### EXAMPLE 1

with a low (volume) thickness, thermal properties are obtained, compared to other insulators that required a higher volume or thickness.

### EXAMPLE 2

once dry, the thermal coating paint does not require any additional protection against the solar rays, water or the environment, unlike other common insulators which require in some cases an acrylic covering or steel/aluminum sheets to protect them against solar rays, water, and the environment.

To support the above given information the following field data is reported:
1. Thermal conductivity tests were effected to the thermal, flexible and light coating paint. These tests were compared with other thermal insulators with the same thickness and volume. The results of the thermal, flexible and light coating paint were better in terms of lower conductivity than other thermal insulators.
2. Thermal conductivity evaluation to determine the R factor (thermal resistance factor) and K factor (thermal conductivity factor) were affected at the CENTRO DE INVESTIGACION DE QUIMICA APLICADA of the CONACYT according to the NOM C189 or ASTM C518 standards.
3. Accelerated weathering by QUV was effected with favorable results.
4. Tests to evaluate adhesion over different surfaces like concrete, metal sheets, wood, etc. with favorable results.

This field data has no intention to limit the reach and benefits of the invention; any variation with the same supported and described results should be considered as a property of the inventor.

1. (canceled)

2. (canceled)

3. A procedure f or preparing a thermal, flexible and light coating paint comprising reacting a ramified chain polymer and modified acrylic with controlled addition of materials, including pigments, to form internal caverns in a coating paint, said thermal flexible and light coating paint having adhesion and autoprotection against water and solar rays upon environmental exposure thereto.

4. The procedure according to claim 3, wherein the internal caverns are formed having controlled humidity sufficient for the coating paint to form a monolithic film of low thickness and volume in comparison to films in absence of said internal caverns.

5. A procedure for preparing a thermal flexible and light coating paint comprising adding to a ramified chain polymer predetermined materials in a temperature of 77° F. to 86° F. at a ratio of said polymer to said materials of 50:5 with a 35% controlled humidity and at a pH of 10.5 to 11 until a modified acrylic is provided having caverns formed therein, wherein polymer content is increased until an endothermic reaction occurs.
